(19) United States
(12) Patent Application Publication
(10) Pub. No.: US 2008/0117629 A1
(43) Pub. Date: May 22, 2008

(54) Room lamp for vehicle

(76) Inventor: Jin Ho Hwang, Seoul (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/709,504

(22) Filed: Feb. 22, 2007

(30) Foreign Application Priority Data
Nov. 22, 2006 (KR) 10-2006-0116091

(51) Int. Cl. F21V 7/00

(52) U.S. Cl. 362/235

(57) ABSTRACT

A lamp includes a diffuse light emitter that emits light from a first light source uniformly across its surface, and a concentrated light emitter, having a light passageway extending through the diffuse light emitter. The concentrated light emitter emits light from a second light source as a directed beam. The diffuse light emitter also includes a light guide panel for guiding light toward the surface of the diffuse light emitter, a reflection sheet for reflecting light from the first light source toward the surface of the diffuse light emitter, a diffusion sheet for diffusing light, and a prism sheet for enhancing luminance of light. The light passageway may be integrated with or mounted to the diffuse light emitter, or may be composed of a hole in the diffuse light emitter. The light sources may be cold cathode fluorescent lamps (CCFLs), external electrode fluorescent lamps (EEFLs), or light emitting diodes (LEDs).

### CROSS-REFERENCE TO RELATED APPLICATION

This application claims priority to and the benefit of Korean Patent Application No. 10-2006-0116091 filed in the Korean Intellectual Property Office on Nov. 22, 2006, the entire contents of which are incorporated herein by reference.

### BACKGROUND OF THE INVENTION

(a) Field of the Invention

The present invention relates to a room lamp for a vehicle, and more particularly to a room lamp for a vehicle with both a diffuse light emitter and a concentrated light emitter. The two emitters can be used either alone or in combination.

(b) Description of the Related Art

Generally, a room lamp in a passenger compartment of a vehicle includes a bulb, a lens, and a user-operable switch which turns the bulb on and off. The light emitted from a conventional room lamp is not sufficient to allow a passenger to read a book or a map.

### SUMMARY OF THE INVENTION

The present invention provides a room lamp for a vehicle with both a diffuse light emitter and a concentrated light emitter. The two light emitters may be used individually or in combination.

An exemplary embodiment of the present invention provides a room lamp for a vehicle including a diffuse light emitter that emits light from a first light source uniformly across the surface of the diffuse light emitter. The lamp further includes a concentrated light emitter having a light passageway that extends through the diffuse light emitter. The concentrated light emitter emits light from a second light source as a directed beam.

The diffuse light emitter may also include a light guide panel for guiding light from the first light source toward the surface of the diffuse light emitter, a reflection sheet for reflecting light from the first light source toward the surface of the diffuse light emitter, a diffusion sheet for diffusing light from the first light source, and a prism sheet for enhancing luminance of light from the first light source.

The light passageway may be integrated with the diffuse light emitter, may be composed of a hole in the diffuse light emitter, or may be mounted to the diffuse light emitter.

The light sources may be cold cathode fluorescent lamps (CCFLs), external electrode fluorescent lamps (EEFLs), or light emitting diodes (LEDs).

### BRIEF DESCRIPTION OF THE DRAWINGS

FIG. 1 is a cross-sectional view of a room lamp for a vehicle according to an exemplary embodiment of the present invention.

FIG. 2 is an exploded perspective view of a diffuse light emitter according to an exemplary embodiment of the present invention.

### DETAILED DESCRIPTION OF THE PREFERRED EMBODIMENTS

An exemplary embodiment of the present invention will hereinafter be described in detail with reference to the accompanying drawings.

A room lamp according to an exemplary embodiment of the present invention includes a diffuse light emitter 20 and a concentrated light emitter. The diffuse light emitter 20 acts as either a side projection type or a direct type of back light unit. A first light source 10 transmits light to a side surface or a lower surface of a light guide panel 21, which emits the light uniformly across the surface of the diffuse light emitter 20. The concentrated light emitter includes a second light source 10, and at least one light passageway 24 disposed through the diffuse light emitter 20, so that light of the light source 10 is emitted in one or more directed beams through the passageways 24.

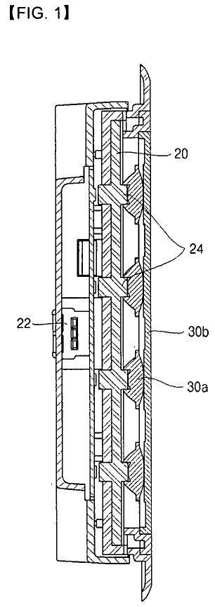

As shown in FIG. 1, a concentrated light emitter according to an exemplary embodiment of the present invention includes a light source 10 supplied with electric power from a battery, at least one light passageway 24, at least one inner lens 30a, and an outer lens 30b. The lenses 30a, 30b direct light emitted from the light source 10 into the passenger compartment of a vehicle.

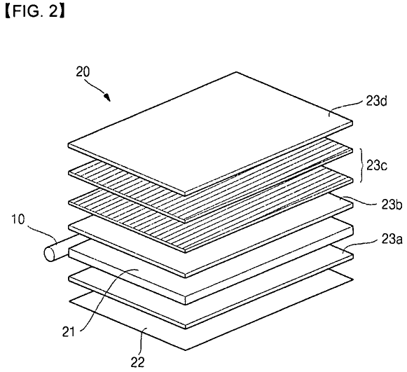

As shown in FIG. 2, a diffuse light emitter 20 includes a light source 10 and a light guide panel 21. The light source 10 may be mounted to a side surface or a lower surface of the light guide panel 21. The diffuse light emitter 20 may further include a reflection sheet 23a, a diffusion sheet 23b, at least one prism sheet 23c, a protecting sheet 23d, and an electric power element 22 such as a printed circuit board (PCB). The light emitted from the light source 10 hits the light guide panel 21 and is emitted therefrom. The portion of the light that is emitted downward in the drawings from the light guide panel 21 is reflected back upwards by the reflection sheet 23a. The reflected light then joins the remainder of the light of the light guide panel 21 and moves upward in the drawing to the diffusion sheet 23b, where it is diffused, and continues its upward path to the prism sheets 23c. The prism sheets 23c enhance the light's luminance. The light then continues to move upwards in the drawing through the protecting sheet 23d and into the passenger compartment.

Referring back to FIG. 1, the light passageway 24 of the concentrated light emitter may be integrated to the diffuse light emitter 20. A hole may be perforated in the diffuse light emitter 20 to form the passageway 24, or a separate passageway structure may be inserted in the diffuse light emitter 20.

Each light source 10 may be a cold cathode fluorescent lamp (CCFL), an external electrode fluorescent lamp (EEFL), a light emitting diode (LED), or the like. In the case of an LED, a single color, or a combination of several different-colored LEDs, may be used, so that color can be selected by a user.

The two light sources 10 can be operated individually or in combination by a user interface device, such as a switch, button, or any other appropriate device. Also, in the case of a combination of colors, color can be selected via the user interface device. Because such devices are well-known in the art, a detailed description is not deemed necessary.

Accordingly, diffuse light is emitted when various colors and smooth mood of light are required, and concentrated light is emitted when bright light is required. Two types of lighting can thus be achieved by one lamp.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A lamp, comprising:
a diffuse light emitter, comprising a first light source, the diffuse light emitter emitting light from the first light source substantially uniformly across a surface of the diffuse light emitter; and
a concentrated light emitter, comprising a second light source and a light passageway disposed through at least a portion of the diffuse light emitter, the concentrated light emitter emitting light from the second light source substantially in a direction of the passageway.

2. The lamp of claim 1, wherein the diffuse light emitter further comprises a light guide panel for guiding light from the first light source toward the surface of the diffuse light emitter.

3. The lamp of claim 1, wherein the diffuse light emitter further comprises a reflection sheet for reflecting light from the first light source toward the surface of the diffuse light emitter.

4. The lamp of claim 1, wherein the diffuse light emitter further comprises a diffusion sheet for diffusing light from the first light source.

5. The lamp of claim 1, wherein the diffuse light emitter further comprises a prism sheet for enhancing luminance of light from the first light source.

6. The lamp of claim 1, wherein the light passageway is integrated with the diffuse light emitter.

7. The lamp of claim 1, wherein the light passageway comprises a hole in the diffuse light emitter.

8. The lamp of claim 1, wherein the light passageway is mounted to the diffuse light emitter.

9. The lamp of claim 1, wherein the first or second light source comprises a member of the group consisting of a cold cathode fluorescent lamp (CCFL), an external electrode fluorescent lamp (EEFL), and a light emitting diode (LED).
